(19) United States
(12) Patent Application Publication
(10) Pub. No.: US 2007/0137197 A1
(43) Pub. Date: Jun. 21, 2007

(54) Engine supercharging system

(76) Inventor: David Turner, Bloomfield Hills, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/313,407

(22) Filed: Dec. 21, 2005

(51) Int. Cl. F02B 33/00; B60T 17/00

(52) U.S. Cl. 60/565; 123/559.1

(57) ABSTRACT

A supercharging system includes a generator having an electrical output and a power transmission mechanism having a mechanical input operatively connected to the engine and a mechanical output operatively connected to the generator. A motor is operatively connected to generator and powered by the electrical output. An air pump is operatively connected to and driven by the motor to provide charged air to the engine.

### BACKGROUND

Engine downsizing has become an increasingly popular option for automotive manufacturers looking to reduce carbon dioxide emissions and improve fuel economy. Unfortunately, the torque produced by a smaller engine can be markedly less than that of a larger one, and while end consumers might accept the reduced emissions and improved fuel economy of a reduced-displacement engine, they still often demand the same driving performance of a larger-displacement engine.

One solution is to pair a reduced-displacement engine with a turbocharger. Turbochargers, which get their power from the flowing exhaust gases produced by internal combustion, are a thermodynamically efficient boosting system, but under some conditions may suffer from lag as the exhaust flow builds to the point where effective boost can be delivered. As engine specific outputs increase, this effect is magnified, limiting the downsizing and carbon dioxide reduction potential offered by conventional turbocharging. Vehicle manufacturers commonly adopt shorter transmission gear ratios to mitigate this effect; however, this generally has an opposite effect to engine displacement downsizing on carbon dioxide emissions performance.

Another option that overcomes the limitations of turbocharging is pairing a reduced-displacement engine with a supercharger mechanically driven by the engine's crankshaft. Although turbo lag may be overcome with the use of a supercharger, conventional superchargers typically have lower compressor efficiency than turbochargers, and cause significant parasitic losses when boost is not required, potentially harming fuel economy and increasing carbon dioxide emissions.

### SUMMARY

A supercharging system for an engine is provided that includes a generator having an electrical output. A power transmission mechanism includes a mechanical input operatively connected to the engine and a mechanical output operatively connected to the generator. A motor is operatively connected to generator and is powered by the electrical output. An air pump is operatively connected to and driven by the motor to provide charged air to the engine.

### BRIEF DESCRIPTION OF THE DRAWINGS

Embodiments of the invention will now be described, by way of example, with reference to the accompanying drawings, wherein:

FIG. 1 is a schematic illustration of a supercharging system according to an embodiment of the present invention;

FIG. 2 is a schematic illustration of a supercharging system according to another embodiment of the present invention; and

FIG. 3 is a schematic illustration of a supercharging system according to another embodiment of the present invention.

### DETAILED DESCRIPTION

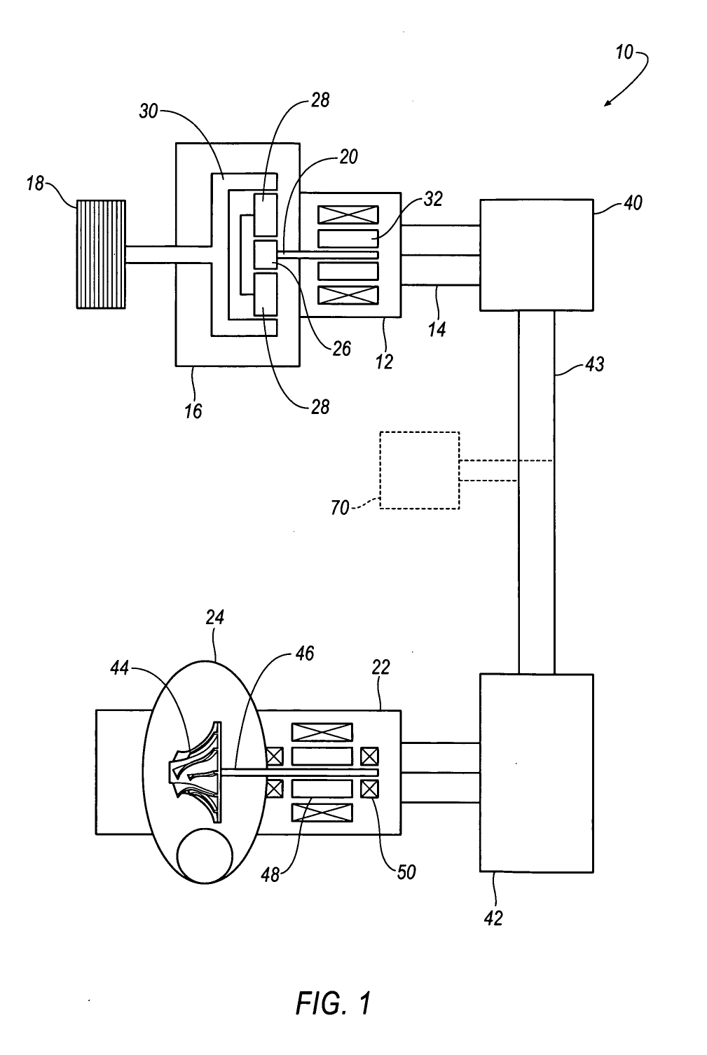

Referring to FIG. 1, a supercharging system 10 for an engine is shown according to an embodiment of the present invention. In the illustrated embodiment, supercharging system 10 includes a generator 12 having an electrical output 14. A power transmission mechanism 16 includes a mechanical input 18 operatively connected to the engine (not shown) and a mechanical output 20 operatively connected to generator 12. A motor 22 is operatively connected to generator 12 and powered by electrical output 14. An air pump 24, including, without limitation, a centrifugal supercharger, is operatively connected to and driven by motor 22 to provide charged air to the engine.

In an embodiment, power transmission mechanism 16 comprises a fixed-ratio power transmission mechanism, whereby the rotational speed of mechanical output 20 is greater than the rotational speed of mechanical input 18, such as, for example, by a factor of thirteen (13). In a particular configuration, power transmission mechanism 16 is a traction-drive device that includes a planetary system having a sun member 26 operatively connected to generator 12 through mechanical output 20, at least one planetary member 28 drivingly interfaced with sun member 26, and an annulus 30 drivingly interfaced with the at least one planetary member 28 and operatively connected to the engine through mechanical input 18. In an embodiment, an elasto-hydrodynamic lubrication oil, such as an automatic transmission fluid (ATF) grade oil, is contained within power transmission mechanism 16 and creates a film between sun member 26, planet member 28 and annulus 30. The oil film exhibits a viscosity that is increasable under pressure created by the closely rotating components of the planetary system to transmit torque between sun member 26, planet member 28 and annulus 30. Compared to a conventional toothed gear system, a traction-drive device can achieve a relatively large gear-ratio. However, the interface between sun member 26, planetary member 28, and annulus 30 may be a geared interface, whereby torque is transmitted between the components by virtue of the meshed gears.

In an embodiment, mechanical input 18 includes a pulley that is mechanically linked to the engine crankshaft (not shown) by a belt, gear or chain, for example. In a particular configuration, the ratio between mechanical input 18 and the engine crankshaft is about 2.5:1. As shown in the following table, for example, power transmission mechanism 16 and mechanical input 18 may cooperate to significantly increase the speed of mechanical output 20 when compared to the engine speed.

| Engine Speed (RPM) | Mech. Output Speed (RPM) |
|---|---|
| 1000 | 32500 |
| 3000 | 97500 |
| 6000 | 195000 |

Since generator 12 produces an electrical output that is generally proportional to its operating speed, a relatively small and inexpensive generator may be employed in supercharging system 10 given the relatively high operating speeds achieved by power transmission mechanism 16 and mechanical input 18.

Mechanical output 20 may include a spindle connected for rotation with sun member 26, which enables a generator rotor 32 to be drivingly supported on the spindle requiring the use of bearings. Generator 12 may be an induction electrical machine or a permanent magnetic electrical machine, for example, the latter including a magnetic field-containing feature, such as an Inconnel sleeve, to contain the magnetic field produced by the permanent magnet. When configured as a permanent magnet electrical machine, generator 12 may be at least 90% efficient over the required power range. While the efficiency of an induction electrical machine may be less than a permanent magnet electrical machine, it does not necessarily require a magnetic field-containing feature.

Referring still to FIG. 1, supercharger system 10 may also include a first power converter 40 operatively connected to generator 12 and a second power converter 42 operatively connected to first power converter 40 and motor 22. In the embodiment illustrated in FIG. 1, first power converter 40 is configured to convert electrical output 14 from alternating current into direct current and second power converter 42 is configured to convert the direct current into alternating current. In a particular implementation of the invention, first power converter 40 may comprise a three-phase rectifier stack including a non-active semiconductor pack and second power converter 42 may comprise an inverter including a number of field-effect transistors (FET) that convert the direct current output of first power converter 40 into variable frequency, three-phase alternating current.

Supercharging system 10 also includes a power transmitting link 43 that may be configured to transmit direct current at various voltages between first and second power converters 40, 42. In an exemplary implementation of the invention, the required electrical power for driving air pump 24 with an efficiency of about 70% is approximately 12kW, assuming a maximum engine speed of about 6000 RPM. To support this power requirement, power transmitting link 43 may be configured to transmit approximately 300V of direct current at about 40 A when the engine is operating at around 6000 RPM. As will be appreciated, the power requirement may depend on the required engine torque-speed curve and the efficiency may not be a steady 70% across the entire curve. Operation of supercharging system at other engine speeds is summarized below:

| Engine Speed | | | Peak Power at |
|---|---|---|---|
| (RPM) | Link Voltage (V) | Line Current (A) | Air Pump (W) |
| 1000 | 50 | 40 | 2000 |
| 3000 | 150 | 40 | 6000 |
| 6000 | 300 | 40 | 12000 |

When supercharger system 10 is configured with a centrifugal supercharger, an impeller 44 is rotatably secured to a shaft 46, which in turn supports a motor rotor 48 for rotation therewith. Unlike generator 12, motor 22 may require a pair of bearings 50 to support rotation of shaft 46, motor rotor 48 and impeller 44. Bearings 50 may be ball bearings, which can require a supply of engine oil for lubrication, or may be plain bearings, which may also require a supply of engine oil for lubrication, but are generally less expensive than ball bearings. Unlike conventional turbocharger applications that use ball bearings to reduce friction and the “spooling-up” time of the turbo impeller when there is relatively little energy in the engine exhaust stream, supercharging system 10 is operable to provide motor 22 with sufficient energy at relatively low engine speeds to allow plain bearings to be used without impacting performance of air pump 24. Moreover, bearings 50 do not need to withstand the relatively high temperatures of the turbocharger environment, since air pump 24 is not within the engine exhaust gas stream. Indeed, air pump 24 may included a plastic housing since it is not subjected to the temperatures of the engine exhaust stream.

As will be appreciated, the mechanical disconnect between the power generating component of supercharging system 10 (i.e., generator 12, power transmission mechanism 16, etc.) and the supercharging component of supercharging system 10 (i.e., motor 22, air pump 24, etc.) permits the supercharging component to be conveniently located at various locations within the engine bay, providing the vehicle manufacturer with greater flexibility in design. Moreover, the location of the power generating component may be farther removed from more traditional supercharger locations adjacent the supercharger component and the engine intake manifold.

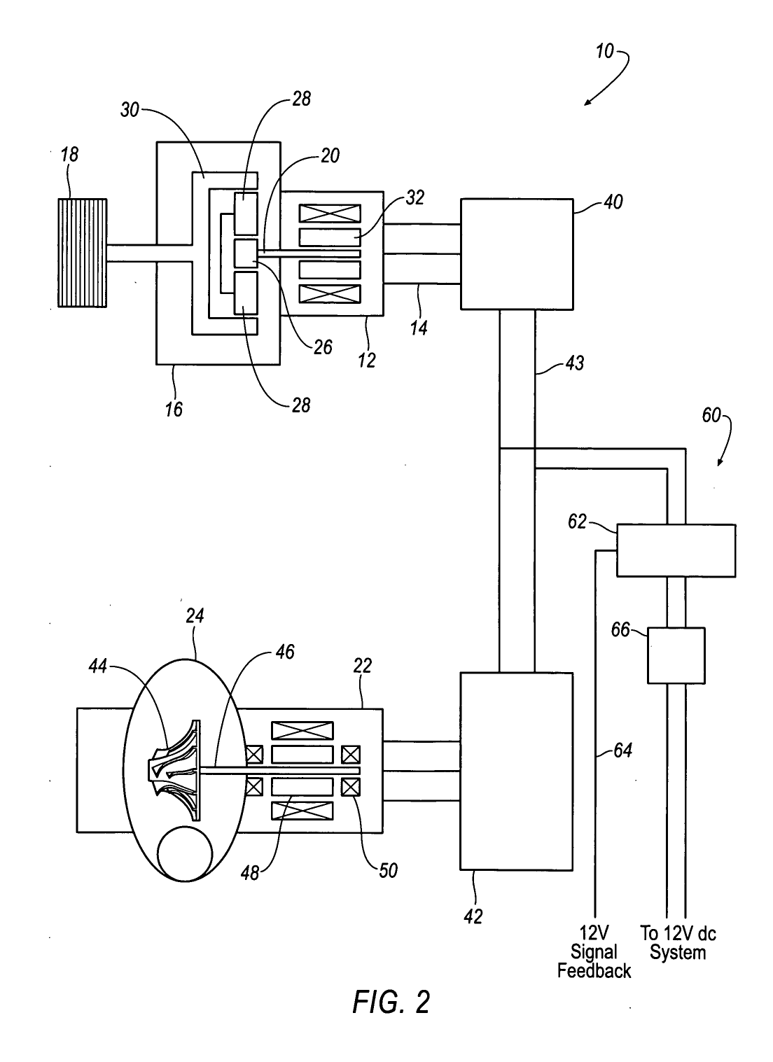

Referring to FIG. 2, another embodiment of the present invention is shown that is substantially similar to the embodiment shown in FIG. 1 with at least one exception, namely, the addition of an auxiliary power supply 60 that is integrated with or connected to a vehicle's existing electrical system. In an embodiment, auxiliary power supply 60 functions as a 12V direct current power supply that is integrated with or connected to a vehicle's existing 12V electrical system. Auxiliary power supply 60 may, for example, include a direct/alternating current regulator and high frequency transformer 62 operatively connected to a power transmitting link 43. The voltage and current regulation is performed on the high voltage side (i.e., power transmitting link side), which allows the use of relatively low cost switching field-effect transistors (FETs). A 12V signal feedback 64 communicates with high frequency transformer 62 and allows a pulse width modulation (PWM) ratio change to be made on the high voltage side. In a particular configuration, transformer 62 includes a pair of FETs rated at about 20 A, assuming a 140 A charge capability to the 12V vehicle electrical system and approximately 50V (e.g., engine speed about 1000 RPM) across power transmitting link 43. A bridge rectifier 66 may be operatively connected to the direct/alternating current regulator and transformer 62 to provide 12V direct current power to the vehicle electrical system. When configured as illustrated in FIG. 2, auxiliary power supply 60 may replace the conventional vehicle alternator.

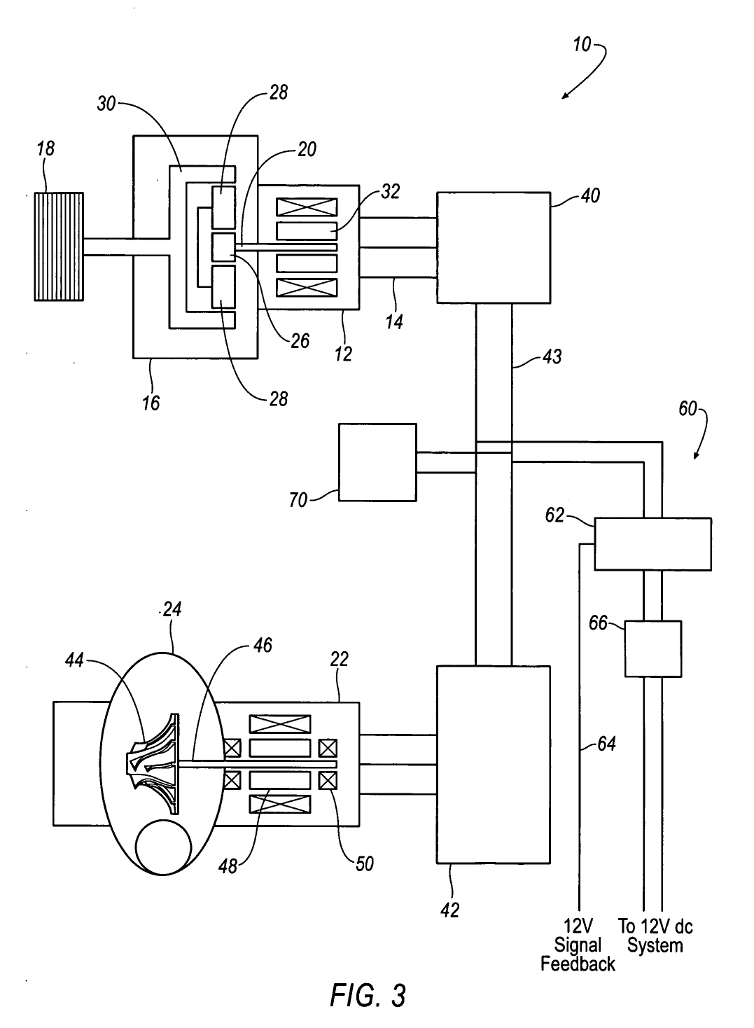

Referring to FIG. 3, another embodiment of the present invention is shown that is substantially similar to the embodiment shown in FIG. 2 with at least one exception, namely, the addition of a capacitor 70 that is connected to supercharging system 10 through power transmitting link 43. When so configured, generator 18 may comprise a motor-generator and first power converter 40 may comprise a two-quadrant inverter, whereby capacitor 70 may selectively supply electrical energy to motor-generator 18 through the two quadrant inverter. In a mode of operation, the electrical energy supplied by capacitor 70 may be used to operate motor-generator 18 as a motor to provide torque to crank (i.e., start) the engine.

In an embodiment, capacitor 70 may include an ultra capacitor bank configured to supply sufficient energy to “warm start” the engine (i.e., start the engine after the engine has been recently operating and then shut-down). In a particular implementation of the invention, motor-generator 18 will require about 80 A to crank the engine on a 12V power supply. Assuming the engine is not shut-down without at least 50V on capacitor 70, the current rating would be about 20 A (i.e., 80 A/50V×12V), well less than the 40 A capability of first power converter 40 during its normal duty cycle. In the above-described embodiment, the conventional vehicle 12V starter motor is still used to “cold start” the engine. However, capacitor 70 and first power converter 40 may be sized to supply the necessary current to motor-generator 12 to “cold start” the engine.

The embodiment illustrated in FIG. 1 may also include capacitor 70, which enables a reduction in the size of power transmission mechanism 16 and a corresponding reduction in electrical output 14 and current-carrying capacity of first power converter 40. In this embodiment, capacitor 70 acts as a load-leveling device and power transmission mechanism 16, generator 12 and first power converter 40 may only need be rated to the average value needed for normal stop-go driving.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A supercharging system for an engine, comprising:
a generator having an electrical output;
a power transmission mechanism having a mechanical input operatively connected to the engine and a mechanical output operatively connected to the generator;
a motor operatively connected to the generator and powered by the electrical output; and
an air pump operatively connected to and driven by the motor to provide charged air to the engine.

2. The supercharging system of claim 1, wherein the power transmission mechanism comprises a fixed-ratio power transmission mechanism, whereby the speed of the mechanical output is greater than the speed of the mechanical input.

3. The supercharging system of claim 1, wherein the power transmission mechanism comprises a traction-drive device including a planetary system having a sun member operatively connected to the generator through the mechanical output, at least one planetary member drivingly interfaced with the sun member, and an annulus drivingly interfaced with the at least one planetary member and operatively connected to the engine through the mechanical input.

4. The supercharging system of claim 3, wherein the power transmission mechanism includes an elasto-hydrodynamic lubrication oil film between the sun member, the planet member and the annulus, the oil film having a viscosity that is increasable under contact surface pressure to transmit torque between the sun member, the planet member and the annulus.

5. The supercharging system of claim 3, wherein the mechanical output includes a spindle connected for rotation with the sun member and the generator includes a rotor drivingly supported on the spindle.

6. The supercharging system of claim 1, the mechanical input includes a pulley that is mechanically linked to an engine crankshaft by a belt, gear or chain.

7. The supercharging system of claim 1, wherein the generator is one of an induction electrical machine and a permanent magnetic electrical machine, the permanent magnetic electrical machine including a magnetic field-containing feature.

8. The supercharging system of claim 1, further including a first power converter operatively connected to the generator and a second power converter operatively connected to the first power converter and the motor, wherein the first power converter is configured to convert the electrical output from alternating current into direct current and the second power converter is configured to convert the direct current into alternating current.

9. The supercharging system of claim 8, wherein the first power converter comprises a three-phase rectifier stack including a non-active semiconductor pack.

10. The supercharging system of claim 8, wherein the second power converter comprises an inverter including at least one field effect transistor (FET).

11. The supercharging system of claim 9, further including an auxiliary power supply.

12. The supercharging system of claim 11, wherein auxiliary power supply is a 12V DC power supply.

13. The supercharging system of claim 11, further including a power transmitting link between the first power converter and the second power converter, and wherein the auxiliary power supply includes a direct/alternating current regulator and transformer operatively connected to the power transmitting link and a bridge rectifier operatively connected to the direct/alternating current regulator and transformer.

14. The supercharging system of claim 8, further including a power transmitting link between the first power converter and the second power converter, wherein a capacitor is operatively connected to the power transmitting link.

15. The supercharging system of claim 14, wherein the generator comprises a motor-generator and the first power converter comprises a inverter, whereby the capacitor is configured to selectively supply electrical energy to the motor-generator through the inverter to operate the motor as a motor to provide torque to the engine through the power transmission mechanism.

16. The supercharging system of claim 1, wherein the air pump is a centrifugal supercharger.

17. A supercharging system for an engine, comprising:
a generator having an alternating current electrical output;
a fixed-ratio power transmission mechanism having a mechanical input operatively connected to the engine and a mechanical output operatively connected to the generator;
a first power converter operatively connected to the generator and configured to convert the electrical output from alternating current into direct current;
a second power converter operatively connected to the first power converter and configured to convert the direct current into alternating current;
a motor operatively connected to the second power converter and powered by the alternating current; and
an air pump operatively connected to and driven by the motor to provide charged air to the engine.

18. The supercharging system of claim 17, further including a power transmitting link between the first power converter and the second power converter, and an auxiliary power supplied connected to the power transmitting link, wherein the auxiliary power supply includes a direct/alternating current regulator and transformer operatively connected to the power transmitting link and a bridge rectifier operatively connected to the direct/alternating current regulator and transformer.

19. The supercharging system of claim 17, further including a power transmitting link between the first power converter and the second power converter, and a capacitor operatively connected to the power transmitting link, wherein the generator comprises a motor-generator and the first power converter comprises a inverter, whereby the capacitor is configured to selectively supply electrical energy to the motor-generator through the inverter to operate the motor as a motor to provide torque to the engine through the power transmission mechanism.

20. A supercharging system for an engine, comprising:
a motor-generator;
a fixed-ratio power transmission mechanism having an input operatively connected to the engine and an output operatively connected to the generator;
a first power converter operatively connected to the motor-generator and configured to convert alternating current generated by the generator into direct current;
a second power converter operatively connected to the first power converter by a power transmitting link, the second power converter configured to convert direct current into alternating current;
an auxiliary power supply operatively connected to the power transmitting link;
a capacitor operatively connected to the power transmitting link and configured to selectively supply electrical energy to the motor-generator through the first power converter to operate the motor-generator as a motor to provide torque to the engine through the power transmission mechanism;
a motor operatively connected to the second power converter; and
an air pump operatively connected to and driven by the motor to provide charged air to the engine.
